(19) United States
(12) Patent Application Publication
(10) Pub. No.: US 2013/0108971 A1
(43) Pub. Date: May 2, 2013

(54) Rooftop high-efficiency gas furnace control with condensate management

(71) Applicants: Dennis R. Maiello, Bloomington, MN (US); Dennis S. Gambiana, Maple Grove, MN (US)

(72) Inventors: Dennis R. Maiello, Bloomington, MN (US); Dennis S. Gambiana, Maple Grove, MN (US)

(73) Assignee: Varidigm Corporation, Plymouth, MN (US)

(21) Appl. No.: 13/317,957

(22) Filed: Nov. 1, 2011

(51) Int. Cl. F24H 3/02; G05D 23/00; F24H 9/20; F23N 5/00; F23N 1/02

(52) U.S. Cl. 431/12; 126/116 A; 165/299; 137/1

(57) ABSTRACT

A method for controlling an efficiency and/or a wet/dry transition area of a condensing furnace heat exchanger section. A temperature can be sensed in an air stream entering the heat exchanger section, to sense an incoming air temperature of the air stream entering the heat exchanger section. A relationship can be established between the incoming air temperature and an air/fuel mixture to be supplied to a burner. The air/fuel mixture can be adjusted to enhance the efficiency and/or to minimize or reduce unwanted condensation within the heat exchanger section.

### BACKGROUND OF THE INVENTION

1. Field of the Invention

This invention relates to a method for controlling an efficiency of a condensing furnace heat exchanger by sensing and controlling operating parameters to minimize or reduce unwanted condensation, particularly from condensate-corrosive surfaces of the heat exchanger section.

2. Discussion of Related Art

It is known in the HVAC industry to design high-efficiency, gas-fired forced air furnaces to optimize fuel usage in residential and commercial heating applications. Conventional mid-efficiency, non-condensing furnaces are limited to steady state efficiencies of 83% or less to limit corrosion in flue passages which causes premature failure of heat exchanger surfaces and other components in the flue stream. Conventional high-efficiency condensing furnaces can obtain efficiencies over 98% and are designed to produce and manage condensate from the combustion products to protect heat exchanger components and remove condensate from an appliance to a proper disposal site, such as a floor drain. Many conventional furnace designs are for non-weatherized furnaces intended for indoor or isolated combustion installations, where the condensate is maintained above a freezing temperature.

For commercial buildings, conventional heating and cooling equipment can be designed into a common, self-contained weatherized unit and installed on a roof of the building. Conventional mechanical devices for circulating air in the occupied space and heating and cooling this circulated air, to maintain comfort to the occupants, are often housed in a rooftop package unit and thus exposed to the external environment or regional climate. Extreme temperatures, such as extreme heat during the cooling season or extreme cold during the heating season, can challenge the system design.

As fuel costs increase and building tenants struggle to control operational costs, more efficient equipment can be installed to minimize energy consumption. For conventional installations using gas-fired forced air furnaces integrated into the rooftop equipment, upgrading the furnace to a high-efficiency design can be restricted or limited in view of difficulties with managing and disposing of the condensate produced by the conventional appliances. Some design challenges arise, for example, when trying to prevent the condensate from freezing in any part of the system, because providing a drain line and trap impervious to cold ambient conditions and insuring that the furnace efficiency does not increase due to colder incoming air over the heat exchanger can cause condensation in portions of the furnace that are not designed to handle the condensate produced. Any system with these design considerations must be easy to install, maintain and service.

### SUMMARY OF THE INVENTION

This invention integrates a mechanical design with digital control logic to better accommodate installing a high-efficiency, condensing gas-fired furnace as part of a weatherized rooftop package unit. In designing some embodiments of this invention, there are five primary areas of interest according to this invention.

First, in some embodiments of this invention, an extended condensate sump of sufficient depth creates gravity flow can be used to overcome a negative pressure generated by the induced draft blower on that portion of the heat exchanger. This type of a sump can be at least six inches deep and have a volume to contain one or two gallons of condensate, for example. In some embodiments of this invention, the sump is located in a non-freezing area of the furnace and is or can be integrated with the existing condensate collector box of the heat exchanger.

Second, in some embodiments of this invention, an electrically controlled valve, such as a solenoid valve or a ball valve, controls fluid flow, such as condensate flow, from the condensate sump. This type of valve can be used as a drain line trap during normal operation, such as when the valve is closed, and/or can be activated when the condensate level reaches a predetermined level, for example, to dump or discharge a stored volume of condensate fluid down or through the drain line and to the drain.

Third, in some embodiments of this invention, at least one or at least two water level indication sensors, such as pressure switches or conductance probes, each is used to indicate when the condensate fluid reaches a maximum level to activate a drainage cycle, for example when the drain valve opens, and/or reaches a minimum level to terminate a drainage cycle, for example when the drain valve closes. In some embodiments of this invention, the maximum level of condensate fluid is designed or set so that the condensate level does not become excessive and cause an overflow at the condensate collector box but also can indicate a level of substantial volume to insure a freeze-free drainage cycle. In some embodiments of this invention, the minimum level is designed so that the condensate collector box does not empty completely, insuring a constant trapping action, for example to prevent sewage gases from escaping the drain system, such as into a furnace flue path. The minimum level according to some embodiments of this invention is designed to accommodate an anticipated negative pressure in the condensate collector box, particularly without bypass and possible freezing during a system off-cycle, for example to avoid damage due to expansion caused by freezing water.

Fourth, in some embodiments of this invention, a temperature sensor is in proximity of or near the condensate collector box to monitor the ambient temperature at or near the condensate collection area, particularly during a furnace off-cycle, such as when the furnace produces no heat. In some embodiments of this invention, the sensor emits or sends a signal to a controller that provides an alert or warning when or as the temperature approaches a freezing point, so that the controller executes an algorithm to operate equipment to keep the system from freezing, for example by turning on a circulating blower.

Fifth, in some embodiments of this invention, a temperature sensor in the incoming air stream at or near the primary heat exchanger is used to monitor the return air temperature, for example as the air passes over or across the heat exchanger. In some embodiments of this invention, the outdoor air is introduced via an economizer or a make-up air application, and thus the efficiency of the furnace increases to a point that causes or forms condensation in the primary heat exchanger, which can lead to corrosion and premature failure of parts or components. In some embodiments of this invention, the sensor provides temperature status or other information to the controller, for example, to change or adjust the air-fuel mixture and/or to maintain a proper efficiency during the operation mode.

In some embodiments of this invention, a mechanical condensate management strategy is used and can be programmed or loaded into the furnace controller and/or the condensate controller. Some conventional condensate management designs for high-efficiency appliances collect the condensate in a relatively shallow collector box at or near an end portion of the heat exchanger, and thus allow the condensate to trickle out or discharge at a flow rate about equal to its rate of formation, to collect the condensate in a typical P-trap in the condensate drain line, and/or to flow through the drain line and to the drain. There are several problems with this conventional approach, particularly when the furnace is installed outdoors in a relatively cold environment, atmosphere or ambient. One apparent design problem is associated with the P-trap and its vulnerability to freezing. The relatively slow flow of condensate fluid throughout the drain system can result in ice accumulation or build-up in the lines and eventual frozen drain lines that require repair and/or replacement.

### BRIEF DESCRIPTION OF THE DRAWINGS

This invention is explained in greater detail below in view of exemplary embodiments shown in the drawings, wherein:

FIG. 1 is a schematic diagram of a portion of a furnace system with condensate removal, a condensate controller and a furnace controller, according to one embodiment of this invention; and

FIG. 2 is a schematic diagram of a furnace system with condensate removal, according to another embodiment of this invention.

### DESCRIPTION OF PREFERRED EMBODIMENTS

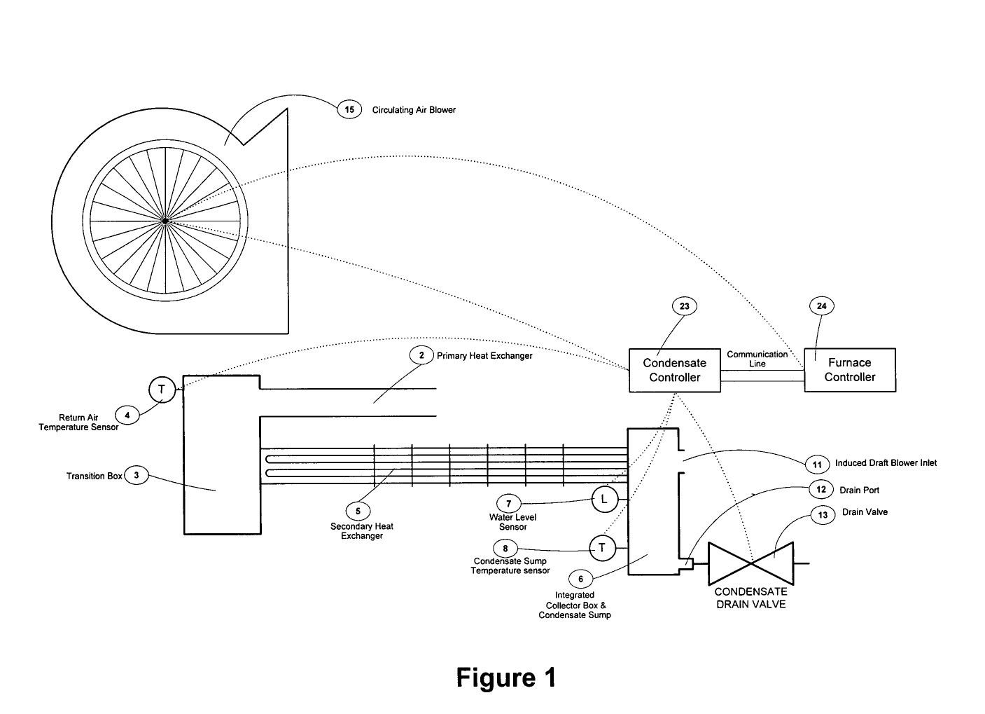

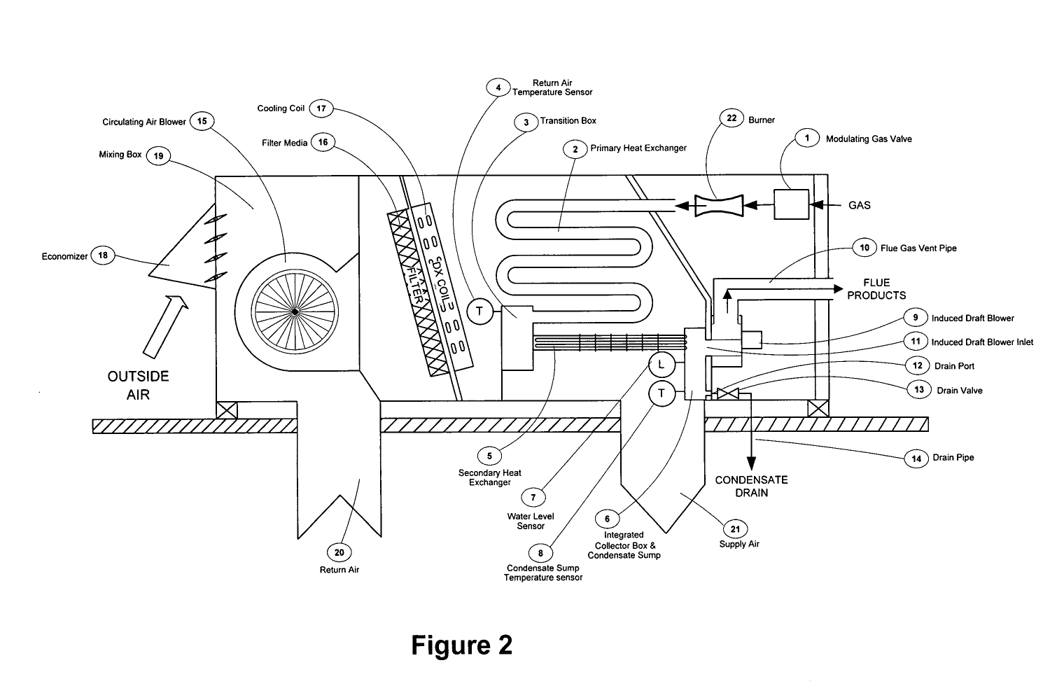

In some embodiments of a condensate management system according to this invention, sump 6, which can be a deep condensate sump, collects a desired or specified volume of water, for example about one gallon or two gallons, in a vessel or container sufficiently deep to overcome a negative pressure in primary heat exchanger 2 and/or secondary heat exchanger 5. For example the vessel or container forming sump 6 can be about six inches deep or can have any other suitable dimension and/or shape. In some embodiments of this invention, such as shown in FIGS. 1 and 2, sump 6 is integrated with a collection box for collecting condensate formed on primary heat exchanger 2 and/or secondary heat exchanger 5. In other embodiments of this invention, sump 6 is not integrated with the collection box but rather is an independent vessel or container, for example that is not integrated into or with a collection box for the overall heat exchanger.

Condensate fluid can flow into sump 6, for example as the condensate forms during the heat transfer process. Because sump 6 is located in or near a non-freezing area of the furnace, in some embodiments, for example in a circulating air stream, the condensate can collect in sump 6, even at a relatively low flowrate, without freezing. Sump 6 can be located in a relatively cold environment, ambient or atmosphere and in some embodiments can be insulated, for example to allow the collected condensate fluid to remain in a liquid state, for example resulting from ambient heat or heat generated by condensate flow from or through heat exchanger 2 and/or heat exchanger 5.

At or near the bottom of sump 6, drain valve 13, which can be a drainage control valve, is connected directly or indirectly to drain port 12. When energized, in some embodiments, drain valve 13 opens and thus drain port 12 opens or forms communication to allow condensate to flow out of sump 6 and into drain line 14, such as shown in FIG. 2. Drain valve 13 may or may not be controlled and can have either a normally-open or a normally-closed design. In some embodiments of this invention, drain valve 13 is a normally-open valve, so that sump 6 can drain, particularly when there is a power interruption or other operating fault. In some embodiments of this invention, drain line 14 has a sufficiently large diameter or other designed size and/or shape to accommodate the condensation flow with no or relatively little flow restriction. In some embodiments of this invention, such as shown in FIG. 2, drain line 14 is a continuous vertical tube from and/or in communication with the outlet of drain valve 13 and can be routed or transferred to, for example, an interior of the building at a level below the furnace.

In some embodiments of this invention, drain valve 13 acts as a trap so that no P-type trap is required, which can be an advantage because a P-type trap can be exposed to freezing temperatures, particularly above a roofline and can also be difficult to service if located below the roofline. However, some local codes may require a traditional trap to be installed in a conditioned space, because a flushing action according to this invention provides a self-cleaning action in the P-type trap.

In some embodiments of this invention, sump 6 comprises level sensor 7, which can sense a level of water or another suitable liquid, mounted with respect to or positioned within sump 6, for example, at a position or location that can signal an appropriate time to drain sump 6. In some embodiments of this invention, such as shown in FIG. 1, when sump 6 closes to a maximum capacity, condensate controller 23 receives a signal from level sensor 7 and condensate controller 23 emits an activation signal and activates or opens drain valve 13 to allow the water or other liquid contained in sump 6 to flow out of or discharge from drain port 12 through drain valve 13 and into drain line 14 which removes the condensate from the furnace, for example to a drain inside the building. The dashed or dotted lines shown in FIG. 1 represent communication lines, wired and/or wireless, between the labeled elements. The relatively large volume of warm or warmer water flowing in a surge amount or surging through drain line 14 can reliably warm or heat drain line 14 where positioned above the roofline, for example, to preclude any significant freezing of the water or other liquid as it passes through the drain system. The surge of warm water can also provide a self-cleaning action for an installed drainage trap in the conditioned space.

In some embodiments of this invention, so that condensate flow from sump 6 into drain line 14 is not restricted or inhibited, the furnace may be adjusted to operate a minimum firing rate, for example by reducing a speed of the combustion blower and thus reducing or minimizing the negative pressure in sump 6. In some embodiments of this invention, after a time period or upon receiving a signal from a second level sensor to indicate proper complete drainage, the control or controller closes drain valve 13 and the process begins again, starts over, recycles or recurs. In some embodiments of this invention, at the end of a heating cycle when the furnace is idle drain valve 13 is maintained in an open position for a set time or a predetermined time period, for example to minimize condensate in the system and thus minimize significant ice build-up or accumulation. Drain valve 13 can then be returned to the closed position, if desired, such as for a remaining period or a remainder of the off-cycle.

For systems that cycle circulating air blower 15, which could leave the furnace with no indoor air circulation during the off-cycle and potentially allow heat exchanger components to cool below freezing, and temperature sensor 8, such as a condensate sump temperature sensor, is installed near, on or inside condensate drain port 12 to indicate when a freezing temperature is approaching, near or a threat. The control system, comprising condensate controller 23 and/or furnace controller 24, can receive an input signal and respond to such a condition by emitting or sending an output signal to turn on to a full speed, turn on to a partial constant or variable speed and/or to turn off circulating air blower 15 or operate the furnace for a short period to avoid freezing or a potential freezing condition.

In some embodiments of this invention, a minimum off-cycle ambient temperature is or temperatures are maintained in, at or near critical drain components, such as a reservoir of condensate sump 6, drain valve 13 and/or another component that is critical to a condensation management function of the furnace. In some embodiments of this invention, temperature sensor 8 or another suitable sensor is located at, in, on or near a discharge of condensate sump 6 and monitors and thus senses when a temperature drops below an established threshold. In some embodiments of this invention, drain valve 13 is in communication with drain port 12 and/or another suitable discharge of and/or in communication with a collector box and/or condensate sump 6.

In some embodiments of this invention, a signal of the sensed temperature is emitted to condensate controller 23 and/or furnace controller 24, which can then activate or deactivate circulating air blower 15 or another suitable furnace component and/or control, for example with no active call for heat. In some embodiments of this invention, furnace burners such as burners 22 each is operated or ran, such as at a predetermined firing rate based on or as a function of the sensed temperature and/or another suitable operating parameter. In some embodiments according to this invention, circulating air blower 15 is operated or run until a time that a sensed ambient temperature exceeds a predetermined threshold and then the operation or running of circulating air blower 15 can be terminated or deactivated. In some embodiments of this invention, operation of burners 22 is limited to a predetermined maximum run time and then operation of circulating air blower 15 is terminated, for example when reaching a maximum run time. In other embodiments according to this invention, operation of burners 22 is limited to a predetermined maximum run time and then circulating air blower 15 is limited to operate to or at a predetermined maximum run time of circulating air blower 15 and then terminate.

In some embodiments of this invention, to further reduce the amount of residual condensate in or at heat exchanger 2 and/or heat exchanger 5, one or more burners 22 might be activated during the off-cycle, for example when the circulating air flow is minimized to raise the temperature of the heat exchanger surfaces to accomplish additional drying.

With rooftop appliances, it is often necessary to monitor or watch the temperature of the return air over heat exchanger 2 and/or heat exchanger 5. Because of the requirements for fresh air ventilation or make-up air in depressurized buildings, in some embodiments of this invention, additional outdoor air is introduced through economizer 18 which is mixed with return air 20 from the conditioned space. With make-up air units, the furnace can condition 100% outdoor air. When this outdoor air is passed over heat exchanger 2 and/or heat exchanger 5, the surface temperatures of each corresponding heat exchanger can be lowered below a dew point temperature of the combustion products, thus causing unwanted condensation in primary heat exchanger 2. Although secondary heat exchanger 5 can be designed for corrosion resistance, primary heat exchanger 2 is normally not designed for corrosion resistance and thus often cannot handle extended wetting times and thus can suffer serious corrosion if operating under conditions promoting surface corrosion. As used throughout this specification and in the claims the term condensate-corrosive surface is intended to relate to and be interchangeable with a description of any surface within the furnace system of this invention that can be damaged and/or corroded by exposure to condensate, particularly unwanted or undesirable condensate, including but not limited to external or exposed outer surfaces of the heat exchanger sections of primary heat exchanger 2 and/or secondary heat exchanger 5.

One possible solution is to limit the amount of outdoor air allowed to enter the unit during cold weather operation. This operating mode could effectively protect from or prevent unwanted condensation formation in, at and/or on primary heat exchanger 2, but this solution might not always be practical from a performance standpoint or as a requirement of the furnace. Because in some embodiments this invention is integrated with a modulating burner control, which for example controls the air/fuel mixture with discreet control of modulating gas valve 1 and the variable capacity induced draft blower 9, it is possible to increase the level of excess air introduced into the combustion process and reduce the effective efficiency of the furnace, such as during cold ambient operation periods. With temperature sensor 4, such as a return air temperature sensor, monitored by furnace controller 24, for example, the air/fuel ratio can be modified as the return air temperature changes, to optimize combustion performance under any and/or all ambient conditions. This function could be dynamically controlled with constant monitoring of the return air temperature sensor and/or by adjusting the combustion air/fuel mixture to maintain condensing of the flue products, particularly in the coil of secondary heat exchanger 5, such as to maintain the dew point of the combustion products above the temperature of the heat exchanger surface. Furnace controller 24 can monitor directly or indirectly the surface temperature of primary heat exchanger 2 and/or of secondary heat exchanger 5, and make adjustments in the air/fuel ratio based on each monitored surface temperature. Conversely, furnace controller 24 can limit the level of minimum modulation to maintain heat exchanger temperatures above a predetermined threshold, such as to minimize condensation by elevating any one or more heat exchanger surfaces above the dew point of the combustion products. In some embodiments of this invention, a combination of adjusting the air/fuel ratio and limiting the modulation range is implemented for additional furnace control, as application needs dictate.

These methods of adjusting or controlling either the air/fuel ratio, heat exchanger surface temperatures and/or the return air temperature are effective, particularly for mid-efficiency furnaces, to reduce or eliminate the potential for condensation in any portion of the heat exchanger, particularly at any condensate-corrosive surface including but not limited to heat exchanger surfaces.

To protect critical components of the furnace, like heat exchanger surfaces or drain components, in some embodiments of this invention, the furnace is activated during the off-cycle, for example when a call for heat is not present to raise the temperature on or around the components, such as above a freezing temperature to insure no formation of or prevent ice in unwanted areas. This run time, in some embodiments of this invention, is limited to insure that the maximum temperature of furnace components is not exceeded, or the temperature of these components are monitored directly or indirectly to indicate the necessary termination of the burner operation.

In some applications, in some embodiments of this invention, the positive pressure in the outlet of induced draft blower 9 pressurizes the drain system and purges residual water from the system. Induced draft blower 9 pneumatically connected to the drainage system with an electrically controlled valve, in some embodiments of this invention, which when opened and the induced draft motor is energized, produces a positive pressure in the drainage system. This method may be more complicated in design with control but can benefit some systems where the geometry of the installation demands additional measures.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A method of controlling an efficiency and/or a wet/dry transition area of a condensing furnace heat exchanger, comprising the steps of:
establishing an air/fuel relationship empirically to modulate the condensing furnace heat exchanger throughout a modulation range;
positioning a temperature sensor in an air stream entering a heat exchanger section to detect an average bulk temperature of the air stream downstream with respect to a mixer for sensing a mixed air temperature when an outdoor air is mixed with a recirculated air;
sensing an incoming air temperature of the air stream entering the heat exchanger section to detect a temperature change in the air stream;
establishing a relationship between the incoming air temperature and an air/fuel mixture supplied to a burner for maintaining an exchanger temperature of a primary heat exchanger of the heat exchanger section which is below a dew point temperature of combustion products that form condensation on a condensate-corrosive surface of the heat exchanger section;
adjusting the air/fuel mixture in the burner to increase excess air and lower a dew point of the combustion products as the sensed incoming air temperature decreases; and
adjusting the air/fuel mixture to the burner dynamically at predetermined increments as a function of the temperature change in the air stream.

2. The method of claim 1 wherein the air/fuel mixture is automatically adjusted.

3. The method of claim 1 further including establishing a relationship between the incoming air temperature and a minimum modulation firing rate of the condensing furnace in which unwanted condensation forms on heat exchanger surfaces and the condensing furnace modulates at a minimum acceptable rate;
adjusting a minimum modulation firing rate of the burner to increase a surface temperature of the heat exchanger section to reduce condensation on the condensate-corrosive surface of the heat exchanger section; and
adjusting the minimum modulation firing rate of the burner dynamically at predetermined increments as a function of the sensed incoming air temperature.

4. The method of claim 3 wherein the minimum modulation firing rate is automatically adjusted.

5. The method of claim 1 further including positioning a second temperature sensor to sense a temperature of the heat exchanger surface at a critical area of the heat exchanger section to reduce the condensation on the condensate-corrosive surface of the heat exchanger section;
adjusting the air/fuel mixture in the burner to increase an amount of excess air in the burner and lower a dew point temperature of the combustion products as the sensed heat exchanger surface temperature decreases; and
adjusting the air/fuel mixture to the burner dynamically at predetermined increments as a function of the sensed heat exchanger surface temperature.

6. The method of claim 5 wherein the air/fuel mixture is automatically adjusted.

7. The method of claim 5 further including establishing a relationship between the sensed heat exchanger surface temperature and the minimum modulation firing rate to reduce condensation forming on the condensate-corrosive surface of the heat exchanger section and to maintain the minimum modulation firing rate;
adjusting the minimum modulation firing rate of the burner to increase heat exchanger surface temperatures to reduce condensation on the condensate-corrosive surface of the heat exchanger section; and
adjusting the minimum modulation firing rate of the burner dynamically at predetermined increments as a function of the sensed heat exchanger surface temperature.

8. The method of claim 7 wherein the minimum modulation firing rate is automatically adjusted.

9. A method of controlling an efficiency and/or a wet/dry transition area of a condensing furnace heat exchanger, comprising the steps of:
establishing a minimum average bulk temperature of an air stream entering a heat exchanger section to maintain a heat exchanger temperature above a minimum temperature;
positioning a temperature sensor in the air stream entering the heat exchanger section to detect an average bulk temperature of the air stream downstream of a mixer for mixing an outdoor air with any recirculated air and sensing any mixed air temperature;
sensing an incoming air temperature of the airstream entering the heat exchanger section to detect a temperature change in the air stream;
changing a damper position of a fresh air damper to reduce an amount of the outdoor air mixed with the recirculated air to maintain a minimum air temperature of the mixed air stream; and
adjusting the damper position dynamically at predetermined increments as a function of the sensed incoming air temperature.

10. The method of claim 9 wherein the damper position is automatically adjusted.

11. The method of claim 9 further including establishing a relationship between the sensed incoming air temperature and the damper position as a function of unwanted condensation forming on heat exchanger surfaces and the minimum temperature at which the furnace operates;
adjusting a minimum fresh air damper position to increase surface temperatures of the heat exchanger to reduce condensation on condensate-corrosive surfaces of the heat exchanger; and
adjusting the fresh air damper position dynamically at predetermined increments as a function of an increase or a decrease of the sensed incoming air temperature.

12. The method of claim 11 wherein the fresh air damper position is automatically adjusted.

13. The method of claim 9 operated in a mid-efficiency, non-condensing furnace.

14. A method of maintaining minimum off-cycle ambient temperatures in or near critical drain components including a reservoir, a drain valve or an other critical component critical to a condensation management function of the furnace, comprising the steps of:
monitoring a temperature sensor located in, on or near a critical condensate management component and sensing when a sensed temperature drops below an established threshold;
igniting furnace burners with no active call for heat;
operating the furnace burners at a predetermined firing rate of the sensed temperature;
operating the furnace burners until a time that a sensed ambient temperature exceeds a predetermined threshold and then terminating the furnace burners operation.

15. The method of claim 14 further including limiting the furnace burners operation to a predetermined maximum run time and then terminating the furnace burners operation when reaching a maximum run time.

16. The method of claim 14 further including monitoring a second temperature sensor located on or near a critical heat exchanger surface to limit a design temperature and terminating the furnace burners operation when a maximum temperature threshold is sensed by the second temperature sensor.

17. A method of purging a liquid condensate from a drain system of a condensing furnace condensate disposal system, comprising the steps of:
controlling an electrically operated drain valve pneumatically connected on a first side to a combustion air blower to supply a positive pressure from the blower and pneumatically connected on a second side to a condensate disposal system that a drain valve and an other critical drain component are positioned downstream from a valve connection point;
opening the drain valve after a burner cycle terminates and energizing the combustion air blower to create the positive pressure in the drain components to force residual liquid condensate from the drain components into a furnace drain line; and
closing the drain valve and de-energizing the combustion air blower after a predetermined time necessary to expel a residual liquid condensate.

18. The method recited in claim 17 further including monitoring an ambient air temperature sensor and opening the drain valve and energizing the combustion air blower only when sensing an ambient air temperature below a predetermined threshold.

19. A method of maintaining minimum off-cycle ambient temperatures in or near critical drain components including a reservoir, a drain valve or an other critical component critical to a condensation management function of the furnace, comprising the steps of:
monitoring a temperature sensor located in, on or near a discharge of a condensate sump and sensing when a sensed temperature drops below an established threshold;
emitting a signal of the sensed temperature to a condensate controller and/or a furnace controller;
activating a circulating air blower with no active call for heat;
operating the circulating air blower at a predetermined blower speed based on the sensed temperature; and
operating the circulating air blower until a time that a sensed ambient temperature exceeds a predetermined threshold and then terminating operation of the circulating air blower.

20. The method of claim 19 further including limiting the furnace burners operation to a predetermined maximum run time and then terminating the circulating air blower operation when reaching a maximum run time.

21. The method of claim 19 further including limiting the furnace burners operation to a predetermined maximum run time and then limiting the circulating air blower operation to a predetermined maximum run time of the circulating air blower.

22. The method of claim 19 wherein the drain valve is in communication with the discharge of the condensate sump.
